(19) United States
(12) Patent Application Publication
(10) Pub. No.: US 2016/0361593 A1
(43) Pub. Date: Dec. 15, 2016

(54) SYSTEM, APPARATUS AND METHOD FOR DETERMINING AND ANALYZING SPORT RELATED ACTIVITIES IN CONJUNCTION WITH LOW LATENCY TRANSMISSION AND PROCESSING

(71) Applicant: Wesley Charles Elliott, Flower Mound, TX (US)

(72) Inventor: Wesley Charles Elliott, Flower Mound, TX (US)

(21) Appl. No.: 14/735,440

(22) Filed: Jun. 10, 2015

(51) Int. Cl. A63B 24/00; G01B 21/00

(52) U.S. Cl. CPC A63B 24/0006; G01B 21/00

(57) ABSTRACT

The present invention generally relates to systems and methods for determining and analyzing sport related activities in conjunction with low latency transmission and processing. Specifically, embodiments of the present invention utilize sensor units placed on participants in a sporting activity in order to identify actions and/or movements made by the participants and analyze those actions and/or movements. In certain embodiments, the system is further configured to transmit the analyzed data associated with those actions and/or movements such that a group of end users (e.g., broadcast viewers, users of a mobile application) can consume the data in real time or near real time.

### FIELD OF THE INVENTION

The present invention generally relates to systems and methods for determining and analyzing sport related activities in conjunction with low latency transmission and processing. Specifically, embodiments of the present invention utilize sensor units placed on participants in a sporting activity in order to identify actions and/or movements made by the participants and analyze those actions and/or movements. In certain embodiments, the system is further configured to transmit the analyzed data associated with those actions and/or movements such that a group of end users (e.g., broadcast viewers, users of a mobile application) can consume the data in real time or near real time.

### BACKGROUND OF THE INVENTION

Sports and sporting events are enormous revenue producers and in every sport there is a great desire to perform at the highest level possible. Trainers, sports teams, athletes and even recreational participants frequently turn to science and technology to improve their techniques, skills, strengths and other attributes.

With this turn to technology, participants have utilized numerous methods to identify and analyze performance data in order to record statistics and/or improve their performance through correcting errors identified in the analysis. From clocking the speed of a baseball pitcher's pitch, measuring a basketball player's vertical jump, to timing any number of sprints and distance runs, recording and analyzing sports data has become ubiquitous.

Additionally, the rise in wearable technology has created new avenues for both professional and amateur sport participants to improve the collection and analysis of data. Most wearables today focus on recording some physical characteristics (e.g., heart rate, perspiration, distance travelled) to provide basic analysis of the participant's overall activities (e.g., calories burned, distance travelled over time, Basal metabolic rate (BMR)). Few, if any, of these wearables provide sensing capabilities sufficient to track and analyze relevant characteristics of professional or even high level amateur athletes and other sport participants.

For instance, in the world of boxing and mixed martial arts (MMA), repetitive striking motions are made, such as punches (e.g., jabs, crosses, hooks, haymakers, uppercuts) and kicks (e.g., heel, front, hook, roundhouse, axe, side). Current wearables are incapable of providing sufficient sensor data to appropriately distinguish and analyze the various types of punches and kicks. At best, current wearables can detect motion characteristics, such as velocity and acceleration. However, current wearables cannot, for instance, distinguish between the various types of punches (e.g., distinguish a jab from an uppercut). Since each punch and kick has different characteristics, it would be desirable to for a wearable to not only identify characteristics of the motion, but identify and analyze the type and form of the motion as well. While boxing and MMA are used as an example, the same applies to most other sport related activities as well (e.g., determining the form of a baseball pitcher to identify whether a fastball or curve ball was being thrown).

Further, analysis of performance data is highly desirable and is regularly utilized and displayed during sporting events. For instance, during broadcast baseball games, it is common for pitch speed to be displayed and during MMA fights, the number of strikes landed and total strikes is displayed. However, this type of information is generally gathered independent from the actual participants in the activities (e.g., baseball pitch speed is recorded by a radar or similar detection means, strikes are generally manually tallied and provided for display manually).

Given that this type of information is highly desirable and adds value to broadcasters and other providers of sporting activities and sporting information, it would be desirable to be able to capture more detailed data points and provide more granular analysis to the end user, whether that be for training purposes (e.g., improve form by analyzing past performance data) or entertainment purposes (e.g., display not only pitch speed, but pitch type, display not only number of strikes, but breakdown number of strikes by type and those of each type that landed).

Finally, given that these sports related activities are normally being consumed in real time or near real time, there is a need to have the data received, processed, analyzed and provided for consumption quickly. For instance, total strikes v. strike landed in an MMA event are normally provided in between rounds or at the end of the fight as opposed to concurrent with each round. Currently, this is not available.

Therefore, there is a need in the art for a system and method for determining and analyzing sport related activities in conjunction with low latency transmission and processing of the analyzed performance data. These and other features and advantages of the present invention will be explained and will become obvious to one skilled in the art through the summary of the invention that follows.

### SUMMARY OF THE INVENTION

Accordingly, embodiments of the present invention are directed to a system and method for determining and analyzing sport related activities in conjunction with low latency transmission and processing of the analyzed performance data.

According to an embodiment of the present invention, a system for determining and analyzing sport related activities in conjunction with low latency transmission and processing, comprises: a sports management module comprising computer executable code stored in non-volatile memory; a processor; a memory; and a communications means, wherein said sports management module, said processor, said memory, and said communications means are operably connected and are configured to: receive sensor data from a plurality of sensors; identify said plurality of sensors based on said sensor data; process sensor data into motion data; determine one or more movements from said motion data; and process said movements into a movement data set, wherein said movement data sat comprises information related to the physical attributes of said one or more movements.

According to an embodiment of the present invention, the sports management module, said processor, said memory, and said communications means are further configured to transmit said movement data set to a cloud computing source.

According to an embodiment of the present invention, the cloud computing source is configured to: receive said movement data set; identify one or more participants associated with said movement data set; retrieve a participant data set associated with said one or more participants, update said participant data set with movement data from said movement data set, wherein said movement data set relates to said participant; and provide access to said participant data set to one or more end users via a network connection.

According to an embodiment of the present invention, the plurality of sensors are distributed between multiple participants of a sporting activity.

According to an embodiment of the present invention, the plurality of sensors are integrated into one or more wearable devices, wherein said wearable devices are attached to one or more participants engaged in a sporting activity.

According to an embodiment of the present invention, the motion data is comprised of velocities along one or more axes, accelerations along one or more axes and changes in velocities or accelerations across one or more axes.

According to an embodiment of the present invention, the sports management module, said processor, said memory, and said communications means are further configured to generate training data from said movement data set, wherein said training data comprises information related to altering said movements such that said movements are more technically correct.

According to an embodiment of the present invention, the sports management module, said processor, said memory, and said communications means are further configured to: retrieve user data associated with a user of at least one of said sensors; associate said user data with said motion data set.

According to an embodiment of the present invention, the sports management module, said processor, said memory, and said communications means are further configured to: retrieve historical training data associated with said user from a data store; generate historical training information from said motion data set and said historical training data; and provide historical training information for display on a display device.

According to an embodiment of the present invention, the historical training information comprises information related to the past and present performance of a user with respect to the movements determined and identified in the motion data.

According to an embodiment of the present invention, a method for determining and analyzing sport related activities in conjunction with low latency transmission and processing comprises the steps of: receiving sensor data from a plurality of sensors; identifying said plurality of sensors based on said sensor data; processing sensor data into motion data; determining one or more movements from said motion data; and processing said movements into a movement data set, wherein said movement data sat comprises information related to the physical attributes of said one or more movements.

According to an embodiment of the present invention, the method further comprises the step of transmitting said movement data set to a cloud computing source.

According to an embodiment of the present invention, the method further comprises the steps of receiving said movement data set; identifying one or more participants associated with said movement data set; retrieving a participant data set associated with said one or more participants; updating said participant data set with movement data from said movement data set, wherein said movement data set relates to said participant; and providing access to said participant data set to one or more end users via a network connection.

According to an embodiment of the present invention, the method further comprises the step of generating training data from said movement data set, wherein said training data comprises information related to altering said movements such that said movements are more technically correct.

According to an embodiment of the present invention, the method further comprises the steps of: retrieving user data associated with a user of at least one of said sensors; associating said user data with said motion data set.

According to an embodiment of the present invention, the method further comprises the steps of: retrieving historical training data associated with said user from a data store; generating historical training information from said motion data set and said historical training data; and providing historical training information for display on a display device.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2A illustrates a schematic of a system for determining and analyzing sport related activities in conjunction with low latency transmission and processing, in accordance with an embodiment of the present invention;

FIG. 2B illustrates a schematic of a system for determining and analyzing sport related activities in conjunction with low latency transmission and processing, in accordance with an embodiment of the present invention;

FIG. 3 illustrates a schematic a sensor device, in accordance with an embodiment of the present invention;

FIG. 4 is an exemplary schematic of a system for determining and analyzing sport related activities in conjunction with low latency transmission and processing, in accordance with an embodiment of the present invention, in accordance with an embodiment of the present invention;

FIG. 5 is an illustration of an exemplary process flow, in accordance with an embodiment of the present invention;

FIG. 6 is an illustration of an exemplary process flow, in accordance with an embodiment of the present invention;

FIG. 7 is an illustration of a network diagram for a cloud based portion of the system, in accordance with an embodiment of the present invention;

FIG. 8 is an illustration of a network diagram for a cloud based portion of the system, in accordance with an embodiment of the present invention;

FIGS. 9-10 show a comparison of punch (impact) detection for a characteristic left hook and left jab; and

FIGS. 11-12 show a comparison of punch (impact) detection for a characteristic left hook and left jab.

### DETAILED SPECIFICATION

The present invention generally relates to systems and methods for determining and analyzing sport related activities in conjunction with low latency transmission and processing. Specifically, embodiments of the present invention utilize sensor units placed on participants in a sporting activity in order to identify actions and/or movements made by the participants and analyze those actions and/or movements. In certain embodiments, the system is further configured to transmit the analyzed data associated with those actions and/or movements such that a group of end users (e.g., broadcast viewers, users of a mobile application) can consume the data in real time or near real time.

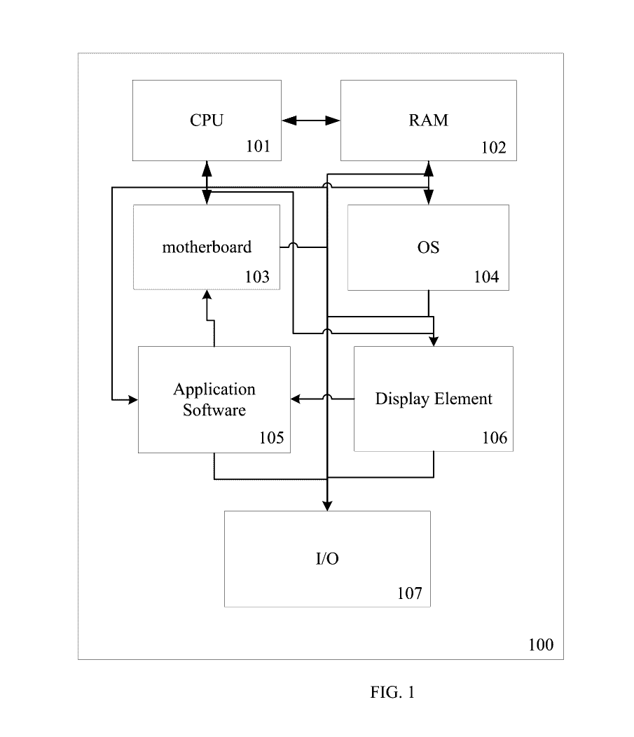

According to an embodiment of the present invention, the system and method shares data to and may be used in conjunction or through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

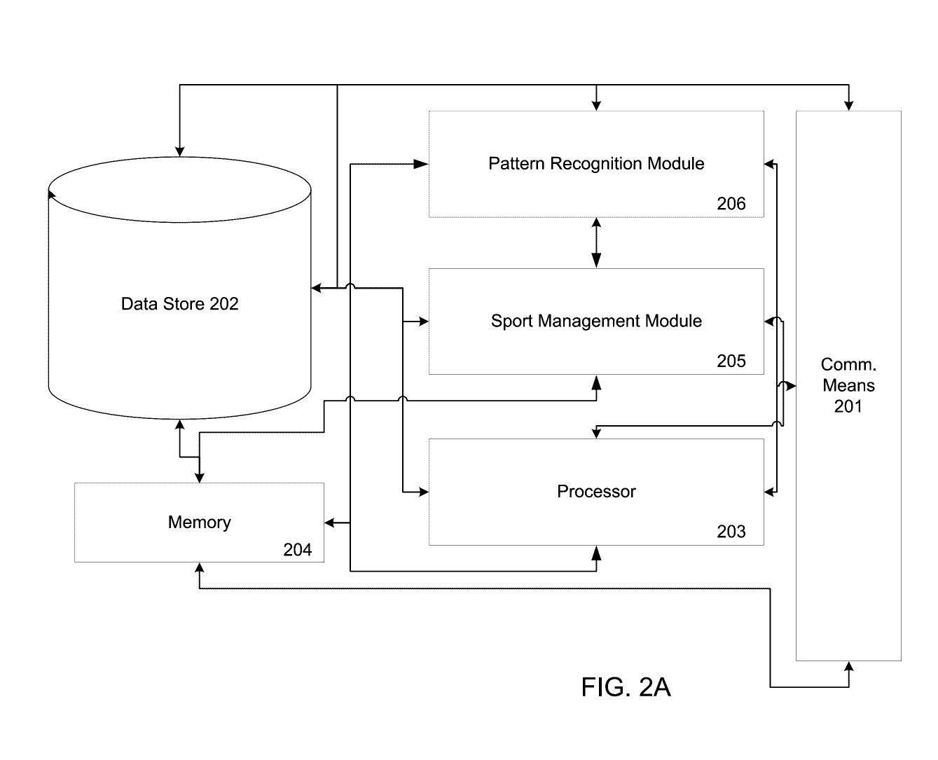

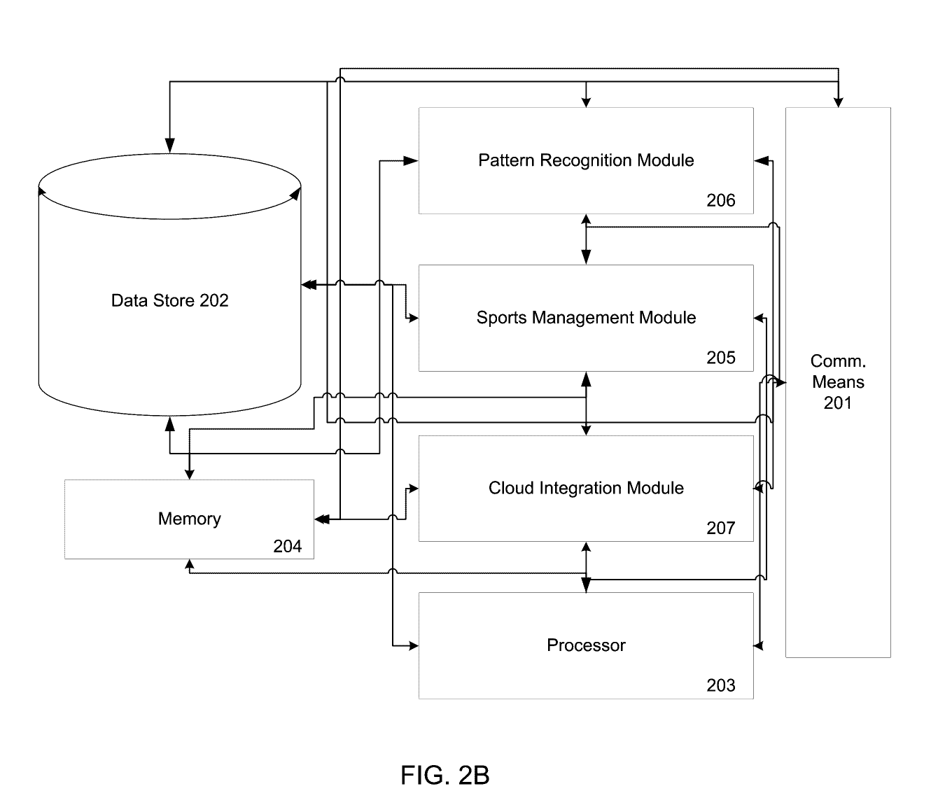

Turning to FIG. 2A, according to an embodiment of the present invention, a system for determining and analyzing sport related activities in conjunction with low latency transmission and processing is comprised of one or more communications means 201, one or more data stores 202, a processor 203, memory 204, a sport management module 205 and a pattern recognition module 206. FIG. 2B shows an alternative embodiment of the present invention, comprised of one or more communications means 201, one or more data stores 202, a processor 203, memory 204, a sport management module 205, a pattern recognition module 206 and a cloud integration module 207. The various modules described herein provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the sports management module is configured to work in conjunction with one or more sensor devices in order to process data received from the sensors and generate data analysis based on motions and movements performed by participants wearing the sensor devices. Further the sports management module may be configured to provide training or other performance related information based on the detected and identified motions and movements of the participant(s). These and other features of the sports management module will be discussed further herein.

According to an embodiment of the present invention, the pattern recognition module is configured to work in conjunction with the sports management module and sensor data in order to identify the movements of participants as can be distinguished from motion data processed from said sensor data. For instance, a pattern recognition module could be configured to work in conjunction with a boxing or MMA participant, wherein the participant has sensor devices located in one or more of their gloves. The motion data collected by the sensors may include position, motion, acceleration and other data, along one or more axes (preferably multiple-axes) and can be used by the pattern recognition module to correlate the motion data with patterns for known movements (e.g., hook, jab, haymaker, uppercut). Once the pattern is recognized, the motion data can be interpreted into movement data and then analyzed one or more metrics (e.g., form, speed, force, acceleration).

While boxing and MMA are simply examples, the sensor data could be used with respect to any sport or motion based activity, including, but not limited to, baseball, basketball, football, Olympic sports, snowboarding, skiing, wrestling, or any other sport or physical activity. For instance, motion data patterns for baseball, sensors could be incorporated into batting gloves, an arm band for a pitcher, or any number of body mounted sensors (e.g., mounted in helmet, mounted in clothing, mounted in shoes) and could include analysis and pattern recognition for movements such as pitch type, swings of a bat, connection with a ball, or any combination thereof.

In other embodiments, motion data patterns for basketball could utilize sensors integrated into armbands or other wearable adapter devices or wearable sensor devices and could include analysis and pattern recognition for movements such as dribbling and other ball handling skills, shooting (including various shot types, such as layups, free throws, dunks) and defensive skills (e.g., setting a pick).

In still further embodiments, motion data patterns for soccer could utilize sensors integrated into shin guards, shoes, armbands, headbands or other wearable sensor devices and could include analysis and pattern recognition for movements such as passing, shooting, dribbling and throw ins. One of ordinary skill in the art would appreciate that there are numerous types of sports and physical activities embodiments of the present invention could be utilized with, and embodiments of the present invention are contemplated for use with any appropriate sport or physical activity.

According to an embodiment of the present invention, the cloud integration module works to integrate the sensor processing portion of the system with one or more distribution networks. In preferred embodiments, the cloud integration module is configured to negotiate both communications and distribution of processing of data such that required data can be correctly processed and provided to end consumers of the data in the most advantageous manner. For instance, the cloud integration module can be configured to off-load data processing of motion data or performance data from a local computing device (e.g., tablet PC, desktop, laptop) to a cloud server system, where the processing requirements would overload or be delayed through local processing. One of ordinary skill in the art would appreciate that there are numerous methods for determining requirements for and distributing such processing requirements, and embodiments of the present invention are contemplated for any appropriate distribution and determination means.

Further, the cloud integration module may negotiate what data needs to be sent to particular cloud servers or providers in order to allow for appropriate consumption by end users. For instance, if a live broadcast of a sporting event (e.g., MMA event, boxing event, soccer match, basketball game) is occurring, the local sensor data may be processed locally by the system and sent to cloud servers of the broadcast providers of the event for consuming the relevant real time or near real time data (e.g., number and type of strikes made by a participant as well as average speed/force or speed/force of specific strikes, number of shots made by a soccer/basketball player).

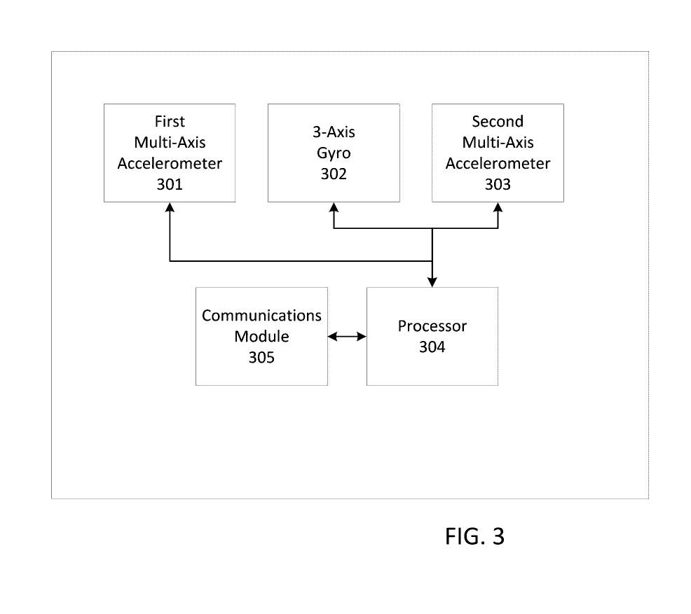

Turning now to FIG. 3, a schematic of a sensor device, in accordance with an embodiment of the present invention, is shown. In this preferred embodiment of the sensor device, the device is comprised of a first multi-axis accelerometer 301, a 3-axis gyroscope 302, a second multi-axis accelerometer 303, a processor 304 and a communications module (e.g., Bluetooth module, BTLE module). Preferred embodiments of the sensor device will generally further incorporate a battery to power the functional components and sensors. Further, preferred embodiments of the sensor device incorporate a wearable component, such as an armband, headband, leg band, chest strap, adhesive component, clip on component, or any combination thereof. However, other embodiments of the sensor device may be configured to be inserted into or otherwise retained upon sporting equipment of the participant, such as, but not limited to, boxing gloves, MMA gloves, shoe pocket, hockey stick, baseball bat, wearable sensor device (e.g., armband, headband, helmet), incorporated into clothing of a participant, or any combination thereof. One of ordinary skill in the art would appreciate that the sensor device could be attached or secured to any number of articles of sporting equipment, and embodiments of the sensor device are contemplated for use with any appropriate article of sporting equipment.

Further, while the exemplary embodiment of the sensor device as shown in FIG. 3 shows a device with 3 total sensors (i.e., 2 multi-axis accelerometers and 1 3-axis gyroscope), one of ordinary skill in the art would appreciate that fewer or additional sensors could be utilized and sensors of various type and kind could be utilized. Embodiments of the present invention are contemplated for use with sensor devices comprising any number and type of sensors, including, but not limited to, heartbeat sensors, humidity (perspiration) sensors, single axis accelerometers, single or multi-access gyroscopes, high G accelerometers, low G accelerometers, or any combination thereof.

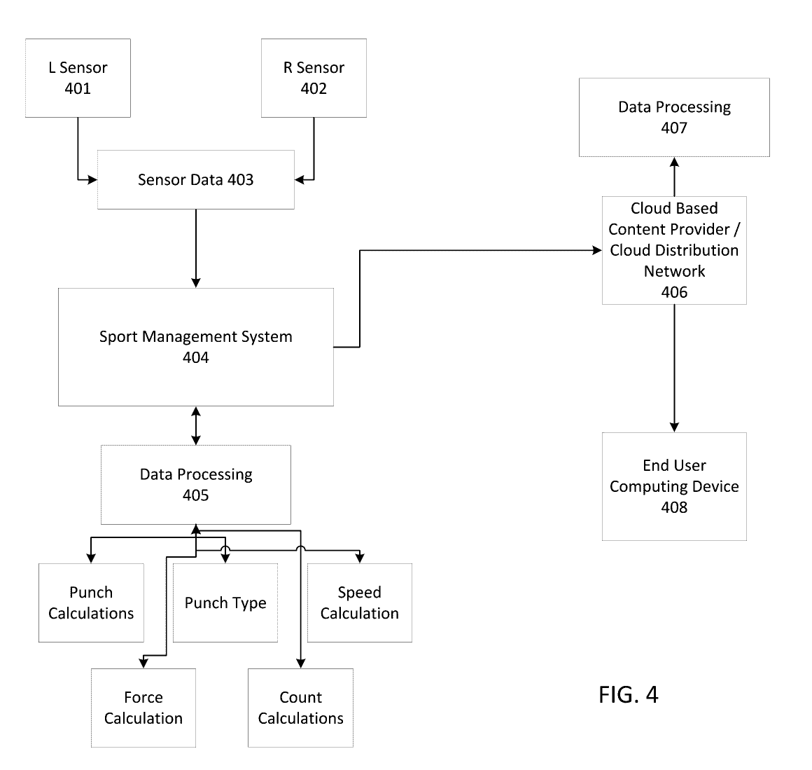

Turning now to FIG. 4, an exemplary schematic of a system for determining and analyzing sport related activities in conjunction with low latency transmission and processing, in accordance with an embodiment of the present invention, in accordance with an embodiment of the present invention, is shown. In this FIG. 4, the flow of data, in accordance with a preferred embodiment of the present invention, is shown. First, the sensor data 403 from a L Sensor 401 (e.g., left boxing glove) and R Sensor 402 (e.g., right boxing glove) are generated and collectively or separately sent to a sports management system 404. It should be noted, here, that while sensor devices (e.g., L Sensor 401, R Sensor 402) have been independently identified up until this point, one of ordinary skill in the art would appreciate that sensor devices may work in a master/slave combination where one sensor device (e.g., L Sensor 401) acts as a master and receives sensor data from one or more slave sensor devices (e.g., R Sensor 402) and the master sensor device handles transmission of the collective data transmission to the sport management system 404. In this manner, slaves may require fewer components than the master component and therefore may be placed in smaller or more inconspicuous housings. One of ordinary skill in the art would appreciate that there are numerous ways to create master/slave relationships among devices and how this may impact the formation of such sensor devices as masters and slaves, and embodiments of the present invention are contemplated for the use thereof.

According to the embodiment shown in FIG. 4, the sports management system 404 is configured to handle data processing 405 of the sensor data 403 on various metrics. For instance, in a boxing example, data processing may include, but is not limited to, determining and calculating punch type, speed, force, total number of punches or any combination thereof. One of ordinary skill in the art would appreciate that there are numerous metrics and data points that could be calculated and provided from the data processing 405 at the sport management system 404, and embodiments of the present invention are contemplated for use with any appropriate metric and data point processing.

Further, according to the embodiment shown in FIG. 4, the sport management system 404 may provide processes (or raw) data to a cloud based content provider and/or cloud based distribution network (CDN) 406. The cloud based content provider 406, for short, could provide additional data processing and curation of data 407 before sending the final product or making the final product available to end user computing devices 408. Additional processing and curation 407 may include, but is not limited to, adding information stored in relation to one or more identified participants in the sport (e.g., boxer wearing L Sensor 401 and R Sensor 402) and generating updated data for that participant before providing information to the end users. For instance, newly provided information about punches thrown from an identified boxer may be added to historical punch data and combined to form a current and accurate set of data points for consumption by the end users. One of ordinary skill in the art would appreciate that there are numerous historical or other metrics (e.g., comparisons between participant and other participants in the same sport) that could be used in such a manner, and embodiments of the present invention are contemplated for use with any appropriate historical data or other metrics.

### Exemplary Embodiments

According to an embodiment of the present invention, the following example is related to an exemplary use case for the system and methods described herein. This embodiment is intended to detail and provide an overview of the features a preferred embodiment of the present invention and should be considered an example and is not intended to limit the scope of the overall invention.

In this embodiment, a system is designed to capture personal training/sparring statistics to help a user track and measure a training routine. The user's data will be tracked in real time or near real time and synced with a cloud based system to allow the user to store the data for future review and allow for remote retrieval at the user's convenience.

In this embodiment, before a training sessions starts, 2 sensor devices (left and right sensor) are assigned to the corresponding hands of the user via a sensorID associated with each sensor device. Each sensor communicates with a sport management system. Each individual sensor device is comprised of 3 microchips: two multi (3) axis-accelerometers (Hi G, Low G) and one 3-axis Gyro.

In this embodiment, each sensor device sends sensor data to the user's sport management system (e.g., desktop PC, laptop, smartphone, tablet PC) where it is locally processed and pattern recognition routines detect various Punch Types based on the sensor data received from the sensor devices. Punch Calculations are also performed locally on the sport management system (e.g., Punch Speed, Force and Count). After punch recognition and calculations are completed, the Punch data (i.e., movement data set) is sent in real time or near real time to a database hosted in on a cloud based system. The database on the cloud based system then communicates the real time data in various formats to Apps on tablets and smartphones.

In this embodiment, Punch data can be used in other ways beyond entertainment and training. For instance, Punch data can be used to assist in decisions regarding fighter safety/head trauma initiatives. By way of example, by determining force calculations and likelihood of head trauma based on impact from force as mitigated by padding of the gloves utilized, determinations can be made as to the safety and efficacy of various glove types and padding thicknesses.

Further in this embodiment, the system can be used on a local server installed on PC/Smartphone for data storage or synced live via internet to the cloud database. In this embodiment, network availability or Wi-Fi may be required to allow data entry interface to the cloud database and in order to allow for synchronization of training history to a calendar.

In this embodiment, the system is designed to provide display elements (e.g., graphical user interfaces (GUIs)), such as punch stats, for training review purposes. The display elements allow fighters/coachers (remote location or gym) to experience a punching bag session with detailed punch statistics. Fighter/Coaches will be able to observe Round by Round statistics for each fighter. The system can track each fighter's statistics and users can view and compare fighter A and fighter B. Display elements may be provided via a computing device, such as a laptop, tablet PC or smartphone.

In this embodiment, a sport management system may provide an administrator feature (e.g., for coaches to track multiple fighters). The administrator feature can be used in conjunction with training data in a gym by a Coach or Fighter. An administrator loads a fighter into the system and assigns specifies the number of rounds for each training session, input the Fighter data (e.g., FighterIDs), and specifies the fighter sensor assignments (pair of sensor devices—Right & Left). The administrator feature should allow import of multiple clients/fighters. The administrator feature can also allow for the addition, editing, deletion of fighters and assignment of sensor devices to fighters and designations of left and right sensor devices.

In an exemplary embodiment, the system captures data streams from 2 sensor devices (L/R from each fighter). The sensor data is processed by a java application that performs pattern recognition to detect punch types and time stamps from the DataStream. Punch algorithms are utilized to identify: jab, straight, hook and uppercut for L/R hand movements based on motion and position data received from the system. Punch types are assigned a force, speed and count values are calculated for average and max per round. A summary is also provided for the conclusion of a training session. The punch type assignments and punch calculations occur in or near real time and are sent to the a cloud database where the data is made accessible to smartphones and tablets for instant viewing. Punch Data/Calculations from sensors are reported locally on the Administrator Laptop in a spreadsheet view or simply stored on a smartphone. Sensor output is also time stamped and stored in an Amazon cloud database, tracks complete history of user activities.

In this exemplary embodiment, a sensor device may output the following exemplary data fields: Sensor ID (Each sensor left and right, a “pair” has 2 unique IDs); Date, time; 20 G Accelerometer—X axis; 20 G Accelerometer—Y axis; 20 G Accelerometer—Z axis; 400 G Accelerometer—X axis; 400 G Accelerometer—Y axis; 400 G Accelerometer—X axis; 20 G Gyro—X axis; 20 G Gyro—Y axis; and 20 G Gyro—Z axis.

In this exemplary embodiment, a punch recognition module analyzes sensor data on an administrator laptop and detects punch type patterns based on acceleration, deceleration, gyro orientation on X,Y,Z axis. Punch Type—calculations may be dependent on fighter stance (Fighter Information): Jab (L,R), Total Count; Straight (L,R), Total Count; Hook (L,R), Total Count; Uppercut (L,R), Total Count; and Unrecognized (L,R), Total Count.

In this exemplary embodiment, a punch recognition module analyzes sensor data on an administrator laptop and detects punch Speed and calculates Max Speed, Avg Speed per round or for bout: Jab (L,R), Max, Avg, Total Count; Straight (L,R), Max, Avg, Total Count; Hook (L,R), Max, Avg, Total Count; Uppercut (L,R), Max, Avg, Total Count; and Unrecognized (L,R) Max, Avg, Total Count.

In this exemplary embodiment, a punch recognition module analyzes sensor data on an administrator laptop and detects punch force: Jab (L,R), Max, Avg, Total Count; Straight (L,R), Max, Avg, Total Count; Hook (L,R), Max, Avg, Total Count; Uppercut (L,R), Max, Avg, Total Count; and Unrecognized (L,R) Max, Avg, Total Count.

In this exemplary embodiment, a punch recognition module analyzes sensor data on an administrator laptop and detects head trauma metrics. Head trauma metrics may include calculation of a Head Injury Criterion (HIC) based on opponent's force and assumes that an individual punch from opponent was delivered to the fighters head without mitigation.

In this exemplary embodiment, the system provides an interface to enter individual user information. Sensor devices will then become assigned to the user so that the system can track the particular user on the cloud server. This also allows the system to collect demographics for particular applications, movement patterns, and technique patterns to better help gyms/trainers determine what's best for the user. For instance, the system may collect information about the fighter “attributes”, including, but not limited to: User ID; Fighter name; Left Sensor ID; Right Sensor ID; Height; Weight; Sex; Reach; Stance—2 Types—Traditional (left foot front) or South Paw/Non-Traditional (right foot front).

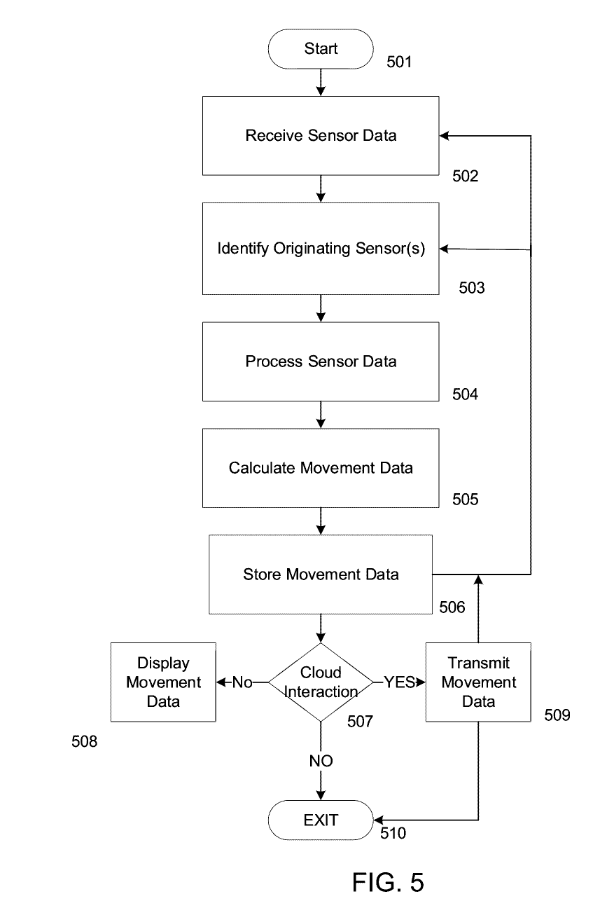

Turning now to FIG. 5, an illustration of an exemplary process flow, in accordance with an embodiment of the present invention, is shown. At step 501, the process starts with the engagement of the sports management system. At this point, the sensor devices are engaged and the system is set to begin receipt of sensor data from the individual sensor devices.

At step 502, the system begins receiving sensor data. As described herein, sensor data is comprised of various data points and will be generally received in a streaming manner in real time or near real time. As such, the process and the steps herein are likely to be happening in parallel, with new sensor data being constantly received and processed while previously received sensor data is still working its way through the process. One of ordinary skill in the art would appreciate the nature of parallel processing and embodiments of the present invention are contemplated for use with processing methodologies, both parallel and in series.

At step 503, the system identifies what sensor(s) are originating the received sensor data. As described herein, a portion of the packets received relates to identifiers for appropriately identifying the sensor device transmitting a particular sensor data packet. The system will reference these sensor identifiers with stored identifiers to match and identify the appropriate participant(s).

At step 504, the system processes the raw sensor data into useable format. This may include, as described elsewhere herein, correlating the various motion data aspects provided by the multi-axis accelerometers, gyroscopes or other sensors and translating that motion data into a series of movements that can be matched against patterns to identify movement types.

At step 505, the system calculates the movement types and motion data into a set of movement data. This is generally in a recognizable format (e.g., Fighter 1 threw a Jab at 2500 lbs of force) that can be utilized later for consumption by end users, participants and/or trainers. At step 506, the movement data is stored locally for later use.

At step 507, the system determines if cloud interaction is desired (e.g., is this data for local use only or to be broadcast to a cloud based system). If the data is not to be transmitted, the movement data is either displayed locally (step 508) or the process terminates at step 510. If cloud interaction is desired, the system transmits the movement data to the cloud at step 509, at which point the process terminates at step 510.

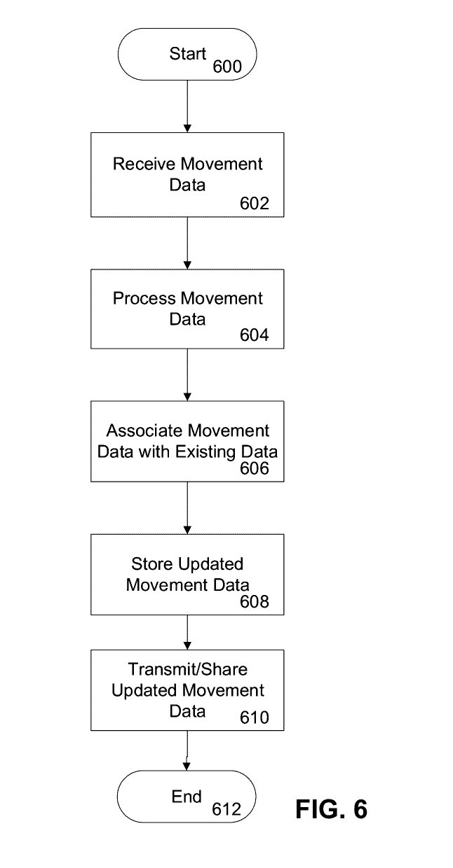

Turning now to FIG. 6, an illustration of an exemplary process flow for a cloud based portion of the system, in accordance with an embodiment of the present invention, is shown. At step 600, the process starts with a sport management system transmitting data to the cloud based portion of the system. At step 602, the cloud system receives the movement data as detailed herein (e.g., See, FIG. 5).

At step 604, the cloud system processes the movement data into a format usable by the cloud system. This may include using identifiers in the movement data to identify participants and identify the ultimate end point for the data to be processed. For instance, if the movement data is associated with a live event, the movement data may be marked as a high priority and processed quickly for provision to consumers of a live broadcast or those with computing devices configured to receive information about the live event.

At step 606, the cloud system associated the movement data with any existing data related to the identified participants. In this manner, newly provided and processed movement data may be added to historical movement data to build an overall picture of the participant. This historical data can be based on any particular metric, such as historical data for a present fight or round if the data is associated with a live event, or over the participants entire career. One of ordinary skill in the art would appreciate that the historical data could be provided over any temporal period, and embodiments of the present invention are contemplated for use with any appropriate temporal period.

At step 608, the cloud system stores any relevant movement data and begins transmission or provision of movement data (e.g., over an API to those who access it) (step 610). At this point, the process terminates at step 612.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

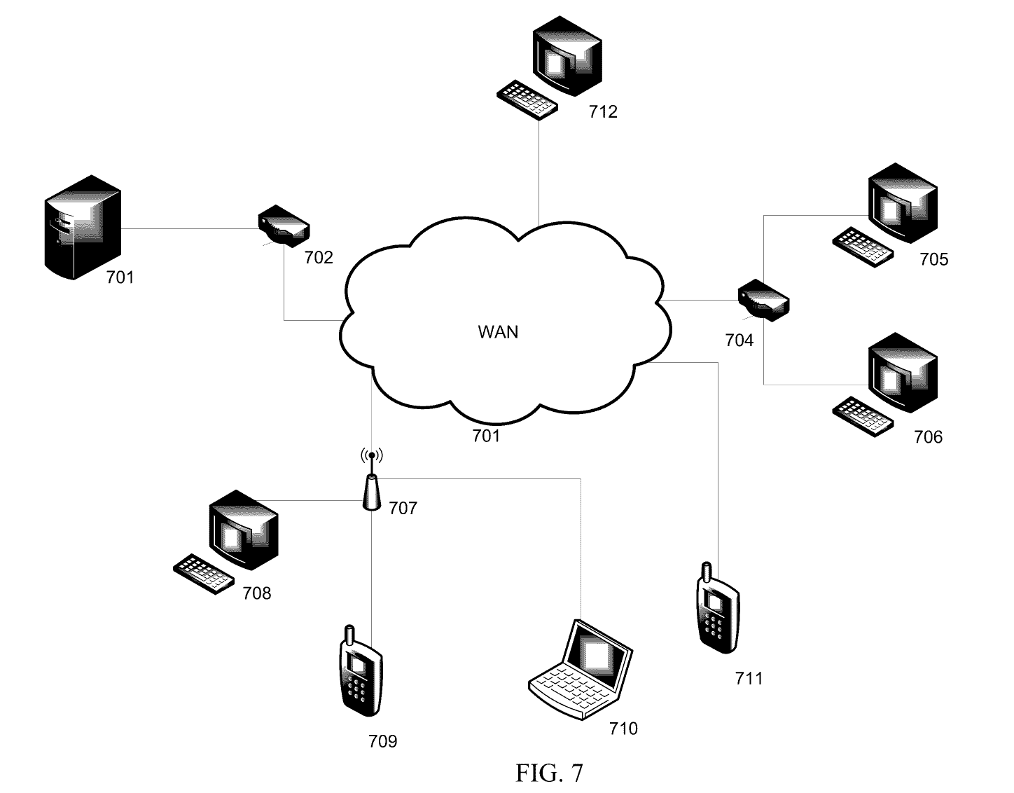

Referring to FIG. 7, a schematic overview of a cloud based system in accordance with an embodiment of the present invention is shown. The cloud based system is comprised of one or more application servers 703 for electronically storing information used by the system. Applications in the application server 203 may retrieve and manipulate information in storage devices and exchange information through a Network 701 (e.g., the Internet, a LAN, WiFi, Bluetooth, etc.). Applications in server 703 may also be used to manipulate information stored remotely and process and analyze data stored remotely across a Network 701 (e.g., the Internet, a LAN, WiFi, Bluetooth, etc.).

According to an exemplary embodiment, as shown in FIG. 7, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art would appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (e.g., CDMA, GMS, 3G, 4G) to the Network 701. One of ordinary skill in the art would appreciate that there are numerous ways that a component may connect to server 703 via Network 701, and embodiments of the present invention are contemplated for use with any method for connecting to server 703 via Network 701. Furthermore, server 703 could be comprised of a personal computing device, such as a smartphone, acting as a host for other computing devices to connect to.

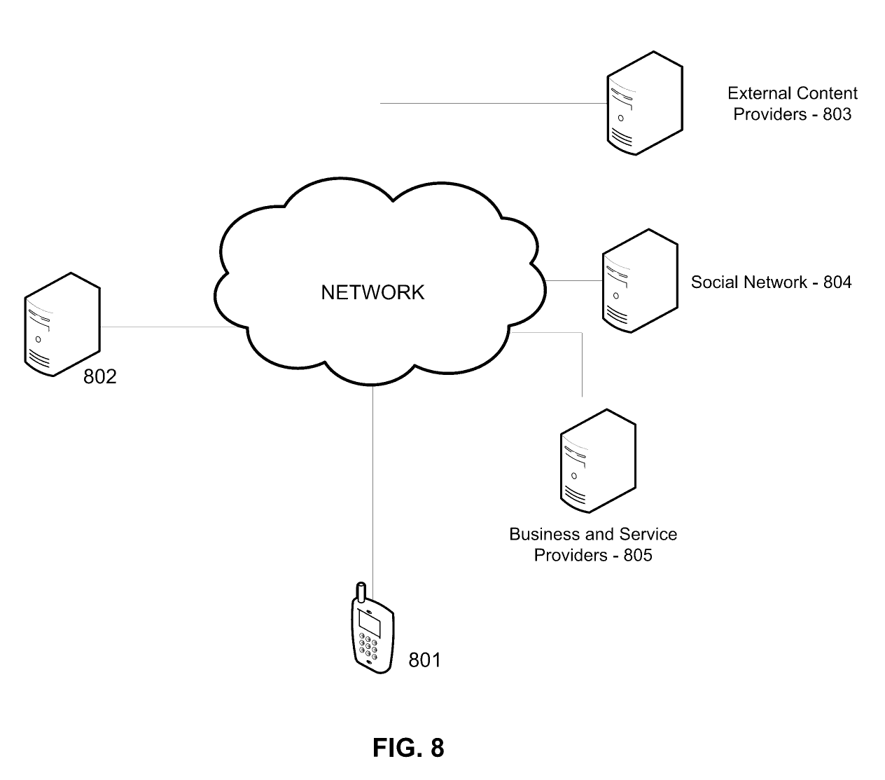

Turning now to FIG. 8, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a social network 804, one or more business and service providers 805 or any combination thereof. Additionally, application server 802 may be able to enhance or otherwise provide additional services to an external content provider API/website or other third party system 803, a social network 804, or one or more business and service providers 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

### Exemplary Embodiments

In order to confirm the accuracy of the force calculations done by a preferred embodiment of the system, sensors are combined with a fixed testing apparatus and a load cell that is capable of measuring the amount of force (e.g., up to 2000 lbf) applied during a movement. For the purposes of the description of this embodiment, the movements will be boxing/mixed martial arts (MMA) reference movements, such as punches. When confirming the accuracy of the speed calculations done by the system, sensors, testing apparatus and load cell are also combined with a pair of photocells which measure the time (in seconds) an object requires to pass through these photocells. Combining the time required to pass through the photocells with the known distance between the photocells, the speed of the object is able to be calculated and translated to the speed of the punch.

Several different laboratory-based tests have been conducted using different combinations of sensors, load cells and photocells. These include Heavy Bag Testing, Gravity-Driven Drop Testing and Pressurized Air Piston Testing.

### Load Cell

A load cell is a device from that is calibrated to be able to accurately measure compressive forces applied to the device using a sampling rate (e.g., 1000 kHz). The data gathered from this load cell is visualized using software. For the purposes of laboratory-based testing, this device will serve as the standard for force measurement. Therefore, for laboratory-based testing conducted, the forces calculated by the system using the sensors will be directly compared to the forces measured by the load cell in order to verify the accuracy of the forces calculated by the system.

### Photocells

Photocells are light-based detectors that can be used to measure the time an object requires to pass through the two photocell gates, within a specified time period (e.g., 0.0001 seconds (0.1 Milliseconds)). With the distance between the two photocell gates known, this distance can be used along with the time required to pass through the photocell gates in order to calculate the speed of the object passing through the photocell speed gates. This method of calculating speed is used in laboratory-based testing in order to calculate the speed of moving objects used to simulate punches. These speed calculations may be directly compared to the speeds calculated by the system using the sensors in order to verify the accuracy of the speeds calculated by the system.

### Heavy Bag Testing

The purpose of heavy bag testing is to simulate the force and speed of an athlete punching a heavy bag during training. This test provides data on the force applied by a given athlete's punch, measured separately by the sensor and the load cell. For this test, the load cell is mounted to the heavy bag using tightly affixed nylon straps. The athlete, while wearing either the MMA or boxing glove outfitted with the sensors, strikes the exposed steel plate.

This test provides data on the force applied by a given athlete's punch as measured by the sensor as well as the load cell. This test aims to compare the force values measured by the sensors and the load cell in order to determine if the sensor is accurately measuring the force of a punch. The load cell is used as the standard for measuring contact force. At the time of contact, the load cell and the System separately display the maximum force of the punch.

### Gravity-Driven Drop Testing

The purpose of gravity-driven drop testing is to compare force and speed values produced by the sensors paired with the system to the force and speed values measured by the load cell and photocells under repeatable conditions. For this test, a boxing glove is mounted on a steel cylinder to simulate a hand inside a glove. A load cell was placed in contact with the boxing glove mount so that the hand of the glove would be in contact with a dropped platform. Two sensors are placed on the platform to be dropped securely with a mechanism to trigger the measurement of speed by two photocells at the moment before contact with the boxing glove. At the time of contact, the computer registers the maximum force applied by the punch as measured by the load cell. The photocell registers the speed of the sensors at the moment before contact and this value is recorded. The system registers the force and speed measured by the sensors and designates these values as left and right. Three specific heights (e.g., 2, 4 and 6 feet) are tested using this system.

This test aims to compare the force and speed values measured by the sensors to force and speed values measured by the load cell and photocells. Using this data, the hardware and software of the sensors are refined to increase accuracy.

### Pressurized Air Piston Testing

The purpose of pressurized air piston testing is to be able to re-create in a laboratory setting the force and speed of a punch delivered by a fighter. The goal is to be able to model punches produced by fighters from each weight class in a laboratory setting. Boxing and MMA gloves are mounted to an air piston which, when fired, passes through photocell speed gates and punches into a load cell in order to measure the speed and force of the punch thrown by the air piston. When the air piston is used together with the system and the load cell, the force and speed values measured by the system are compared to the force and speed values measured by the load cell and photocells.

The system captures data streams from 4 sensors (L/R from each fighter). The sensor data is processed by an application “Processor” that detects punches, creates time stamps and performs pattern recognition to recognize punch types from the DataStream. Punch algorithms are utilized to identify jab, straight, hook, uppercut and unrecognized punches for L/R hand movements. Punch types are assigned and force, speed and count values are calculated for avg. and max per round. A summary is also provided for the conclusion of fight (i.e., Results Screen.) The punch type assignments and punch calculations occur in real time and are sent to the portion of the system located in the cloud, where the data is made accessible to smartphones and tablets for enhanced televised coverage (e.g., TV commentary), and/or entertainment options for second screen opportunities. Punch Data/Calculations from sensors are reported locally on an Administrator Laptop, such as in a spreadsheet view. Sensor output may also time stamped and stored in an cloud database, tracks complete history of user activities.

According to an embodiment of the present invention, the sensors should be oriented correctly in order to accurately detect punches, calculate speed and recognize punch patterns in order to categorize punches as a jab, straight, hook or uppercut. In a preferred embodiment, the sensors are positioned toward the knuckles, for both the left and right hand gloves

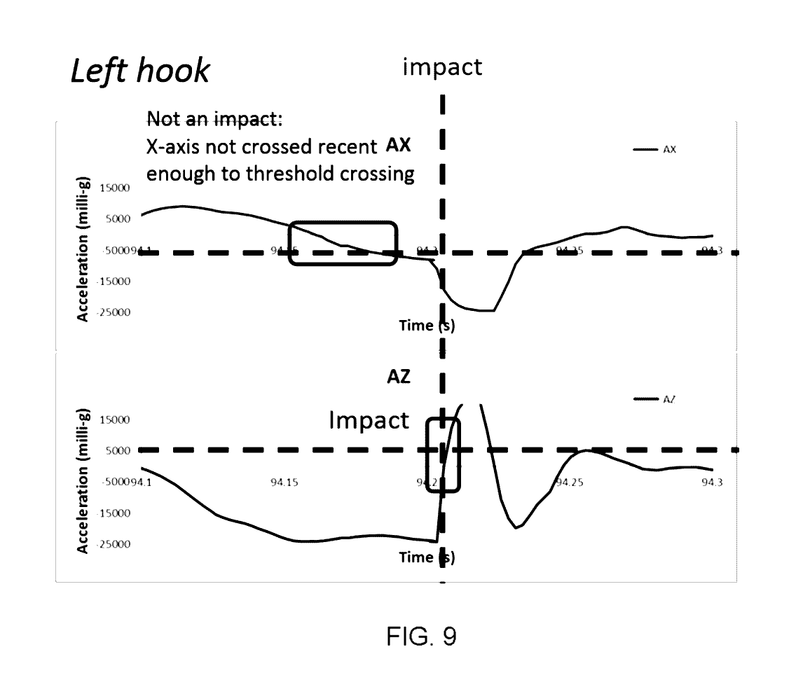

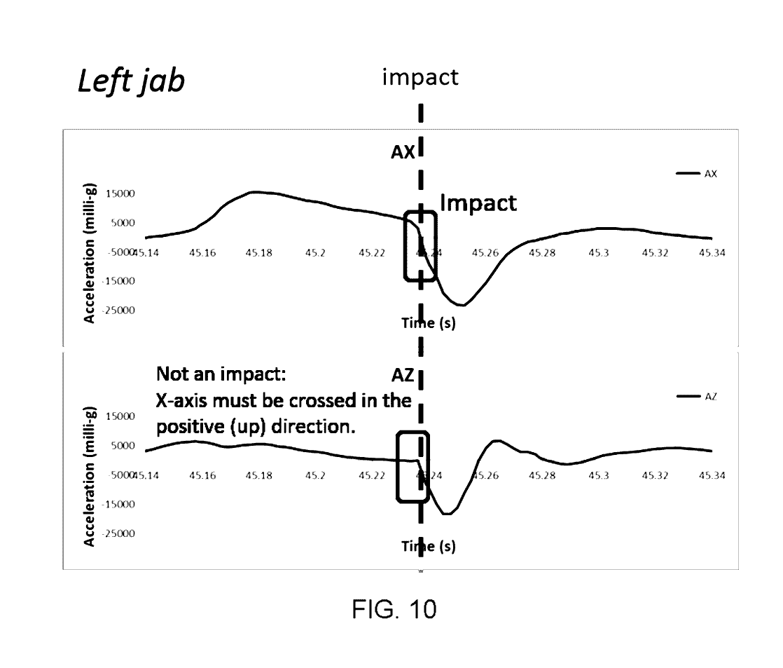

According to an embodiment of the present invention, the system uses characteristic features in the sensor to provide and analyze data immediately before and after impact in order to detect a punch. In a preferred embodiment, punches are detected using data from the x and z axes of a low G accelerometer. FIGS. 9-10 show a comparison of punch (impact) detection for a characteristic left hook and left jab. The hook and jab are used in this comparison because the hook closely resembles the uppercut due to the natural curved motion of the hands when throwing both hooks and uppercuts, while the jab and the straight are the same punch thrown from different hands.

FIGS. 9-10 show a graphic example of left hook and left jab punch detection as may be displayed after processing via an application processor. One of ordinary skill in the art would note that this graphic does not describe how to recognize a punch as a jab or hook, it is merely presenting an example of punch (impact) detection for a left jab and left hook. The threshold values are noted by dashed horizontal lines.

In order to understand what is shown by these graphs, it should be clear that the process of confirming an impact first requires that a threshold value (see horizontal dashed lines) is met. In a preferred embodiment, these threshold values are measured by a low G accelerometer in units of milli-g. Note that a “g” represents the natural gravitational force, or g-force

$$( 9.81 \frac{m}{{s}^{2}} ) .$$

Therefore a milli-g represents one-thousandth of a “g”, or

$$9.81 \times {10}^{- 3} \frac{m}{{s}^{2}} .$$

As mentioned previously, the characteristic features immediately before and after an impact are utilized to detect and confirm a punch has occurred. This process of looking for peaks and analyzing to confirm punches is running constantly in the application processor and utilizes a multistep process.

In a preferred embodiment, a four step process is utilized. First, a threshold crossing event in one of the acceleration axes is used to detect a punch. Based on the specific pattern of acceleration zero crossings and directions (positive or negative) immediately before and after the impact, different punch types are differentiated and recognized. Second, the application processor scrolls back several seconds to retrieve the acceleration data just before the threshold crossing. Third, the application processor calculates whether or not the acceleration data just before the threshold crossing crosses from negative (bottom-half of graph) to positive (top-half of graph) or positive to negative. In order for either process to occur, the acceleration data must cross 0 (zero). This process is referred to as a zero crossing. If no zero crossing is observed in either axis, then the punch (impact) is marked as not a punch. If a zero crossing is observed, then the application processor proceeds to the fourth step. Fourth, the application processor deciphers whether or not the zero crossing in the x axis moves (left to right along the graph) from positive to negative or if the zero crossing in the z axis moves (left to right along the graph) from negative to positive. If yes, the impact is confirmed as a punch and the punch is successfully detected.

### Speed Calculation and Jab/Straight Punch Recognition

Although, according to a preferred embodiment of the present invention, the sensors are constantly collecting acceleration data while a fighter moves his/her arms, it is the acceleration surrounding the moment of impact that is utilized in the speed calculation. For example, if a punch accelerates from the moment the fighter throws it until it comes to a complete stop at impact, then theoretically, the punch had to very rapidly decelerate upon impact, until the punch came to a complete stop. Assuming the impact causes a complete stop of the punch, then the deceleration of the punch upon impact must be equal and opposite in magnitude to the acceleration of the punch before impact. Following this concept, the sensors measure the deceleration (or negative acceleration) of the punch after impact in order to calculate the speed of the punch thrown.

According to an embodiment of the present invention, a calculation of “speed,” of the punch is a several step process that immediately follows punch detection. First, the application processor matches the axis the punch was confirmed in using the Low G accelerometer to the corresponding Hi G axis. Therefore, a punch confirmed in the Low G x axis pairs to the Hi G y axis and a punch confirmed in the Low G z axis pairs to the Hi G z axis. From this point forward, the application processor notes the corresponding Hi G axis that the punch was originally detected and confirmed in. Second, the application processor scans the acceleration data associated with the confirmed punch in the y axis to confirm if the threshold value set for the y axis has been met (currently this threshold is set to −14 g). If yes, a threshold crossing has occurred; proceed to third step. If no, the previous punch confirmation is overruled, the original impact is no longer registered as a “punch” and no further calculations are done. The application processor looks for a threshold value in the y axis of the Hi G accelerometer because the sensor is always directed such that the y axis of the Hi G accelerometer points towards the knuckles. Furthermore, punch types including jabs, straights, hooks and uppercuts generally hit a fighter's knuckles. Third, the application processor scans the data immediately before and after the threshold crossing to determine at what time the peak (minimum) deceleration occurs. The peak deceleration is noted; proceed to fourth step. Fourth, The application processor calculates the punch velocity by calculating the area between the peak and the left and right zero crossing. The green highlighted area in the below figure represents the area used for this calculation. Fifth, the calculated velocity value and the punch type are reported together by the system.

### Hook/Uppercut Punch Recognition

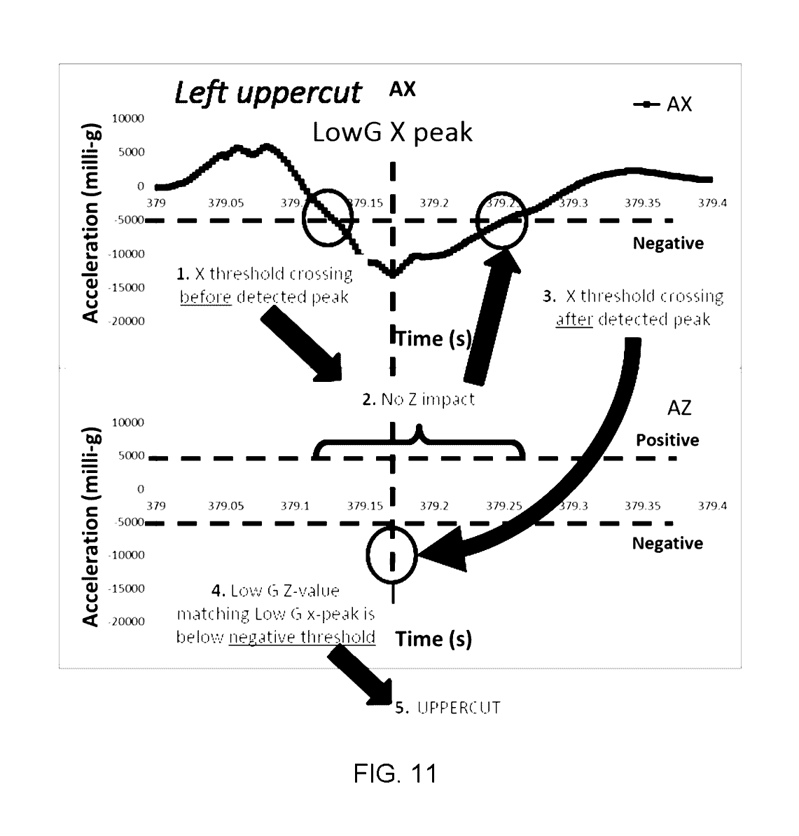

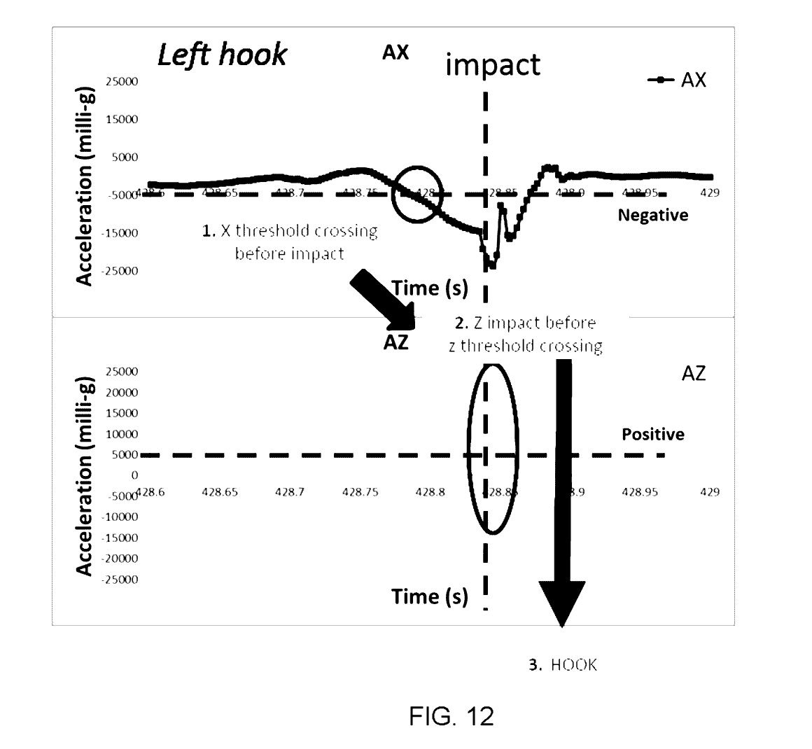

According to an embodiment of the present invention, in order to distinguish between a hook and an uppercut, the application processor revisits the acceleration data from the Low G accelerometer and follows another several step process. First, the application processor looks for a threshold crossing in the x axis before the detected peak in the x axis. Second, The application processor looks for an observed impact in the z axis. If a z impact is observed before the z threshold crossing, the punch is recognized as a hook and no further processing is required. If no z impact is observed, proceed to third step. Third, the application processor looks for an x threshold crossing after the detected peak in the x axis. If an x threshold crossing is not observed after the detected peak in the x axis, the punch is recognized and labeled as an “uncategorized” punch and no further processing is required. If an x threshold crossing is observed after the detected peak in the x axis, proceed to fourth step. Fourth, the application processor looks for a z-value matching the corresponding peak in the x axis that is below the negative threshold for the z axis. If this condition cannot be met, the punch is recognized and labeled as an “uncategorized” punch and no further processing is required. If this is met, the punch is recognized and labeled as an uppercut and no further processing is required. FIGS. 11-12 show an example of this process.

### Punch Force Calculation Tables

According to an embodiment of the present invention, punch force calculation tables may stored locally (e.g., .CSV (Comma Separated Variable), .XLS (EXCEL)) or remotely and data is synced with the cloud (e.g., this data can be sorted by any of the attributes, time, date, force, type, speed). In a preferred embodiment, punch types and stats/calculations are stored locally and in the cloud DB. Each punch is time stamped based on sensor data—to sync with TV broadcasting or other internet or multimedia broadcasting type.

According to an embodiment of the present invention, punch type calculations may be dependent on fighter stance (Fighter Information): Jab (L,R), Total Count; Straight (L,R), Total Count; Hook (L,R), Total Count; Uppercut (L,R), Total Count; and Unrecognized (L,R), Total Count. Similarly, punch speed may be calculated via Max Speed, Avg Speed per round or for bout: Jab (L,R), Max, Avg, Total Count; Straight (L,R), Max, Avg, Total Count; Hook (L,R), Max, Avg, Total Count; Uppercut (L,R), Max, Avg, Total Count; and Unrecognized (L,R) Max, Avg, Total Count. Finally, punch force may also be calculated and stored: Jab (L,R), Max, Avg, Total Count; Straight (L,R), Max, Avg, Total Count; Hook (L,R), Max, Avg, Total Count; Uppercut (L,R), Max, Avg, Total Count; and Unrecognized (L,R) Max, Avg, Total Count.

Punch force calculations are estimated by interpolating between a set scale of forces, accelerations and velocities. These values are combined with experimental measurements of punch acceleration and calculations of punch velocity to estimate the observed force of the punch.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for determining and analyzing sport related activities in conjunction with low latency transmission and processing, the system comprising:
a sports management module comprising computer executable code stored in non-volatile memory;
a processor;
a memory;
and a communications means,
wherein said sports management module, said processor, said memory, and said communications means are operably connected and are configured to:
receive sensor data from a plurality of sensors;
identify said plurality of sensors based on said sensor data;
process sensor data into motion data;
determine one or more movements from said motion data; and
process said movements into a movement data set, wherein said movement data sat comprises information related to the physical attributes of said one or more movements.

2. The system of claim 1, wherein said sports management module, said processor, said memory, and said communications means are further configured to transmit said movement data set to a cloud computing source.

3. The system of claim 2, wherein said cloud computing source is configured to:
receive said movement data set;
identify one or more participants associated with said movement data set;
retrieve a participant data set associated with said one or more participants,
update said participant data set with movement data from said movement data set, wherein said movement data set relates to said participant; and
provide access to said participant data set to one or more end users via a network connection.

4. The system of claim 1, wherein said plurality of sensors are distributed between multiple participants of a sporting activity.

5. The system of claim 1, wherein said plurality of sensors are integrated into one or more wearable devices, wherein said wearable devices are attached to one or more participants engaged in a sporting activity.

6. The system of claim 1, wherein said motion data is comprised of velocities along one or more axes, accelerations along one or more axes and changes in velocities or accelerations across one or more axes.

7. The system of claim 1, wherein said sports management module, said processor, said memory, and said communications means are further configured to generate training data from said movement data set, wherein said training data comprises information related to altering said movements such that said movements are more technically correct.

8. The system of claim 1, wherein said sports management module, said processor, said memory, and said communications means are further configured to:
retrieve user data associated with a user of at least one of said sensors;
associate said user data with said motion data set.

9. The system of claim 8, wherein said sports management module, said processor, said memory, and said communications means are further configured to:
retrieve historical training data associated with said user from a data store;
generate historical training information from said motion data set and said historical training data; and
provide historical training information for display on a display device.

10. The system of claim 9, wherein said historical training information comprises information related to the past and present performance of a user with respect to the movements determined and identified in the motion data.

11. A method for determining and analyzing sport related activities in conjunction with low latency transmission and processing, the method comprising the steps of:
receiving sensor data from a plurality of sensors;
identifying said plurality of sensors based on said sensor data;
processing sensor data into motion data;
determining one or more movements from said motion data; and
processing said movements into a movement data set, wherein said movement data sat comprises information related to the physical attributes of said one or more movements.

12. The method of claim 11, further comprising the step of transmitting said movement data set to a cloud computing source.

13. The method of claim 12, further comprising the steps of:
receiving said movement data set;
identifying one or more participants associated with said movement data set;
retrieving a participant data set associated with said one or more participants,
updating said participant data set with movement data from said movement data set, wherein said movement data set relates to said participant; and
providing access to said participant data set to one or more end users via a network connection.

14. The method of claim 11, wherein said plurality of sensors are distributed between multiple participants of a sporting activity.

15. The method of claim 11, wherein said plurality of sensors are integrated into one or more wearable devices, wherein said wearable devices are attached to one or more participants engaged in a sporting activity.

16. The method of claim 11, wherein said motion data is comprised of velocities along one or more axes, accelerations along one or more axes and changes in velocities or accelerations across one or more axes.

17. The method of claim 11, further comprising the step of generating training data from said movement data set, wherein said training data comprises information related to altering said movements such that said movements are more technically correct.

18. The method of claim 11, further comprising the steps of:
retrieving user data associated with a user of at least one of said sensors;
associating said user data with said motion data set.

19. The method of claim 18, further comprising the steps of:
retrieving historical training data associated with said user from a data store;
generating historical training information from said motion data set and said historical training data; and
providing historical training information for display on a display device.

20. The method of claim 19, wherein said historical training information comprises information related to the past and present performance of a user with respect to the movements determined and identified in the motion data.
